(19) United States
(12) Patent Application Publication
(10) Pub. No.: US 2025/0029620 A1
(43) Pub. Date: Jan. 23, 2025

(54) SPATIAL AUDIO PARAMETER DECODING

(71) Applicant: Nokia Technologies Oy, Espoo (FI)

(72) Inventor: Adriana VASILACHE, Tampere (FI)

(21) Appl. No.: 18/707,301

(22) PCT Filed: Sep. 23, 2022
(86) PCT No.: PCT/FI2022/050642

§ 371 Date: May 3, 2024

(30) Foreign Application Priority Data
Nov. 12, 2021 (GB) 2116345.6

(51) Int. Cl. G10L 19/008; G10L 19/032

(52) U.S. Cl. CPC G10L 19/008; G10L 19/032

(57) ABSTRACT

An apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the apparatus comprising means for: obtaining a spatial audio signal direction index value (306); estimating, by application of a defined polynomial comprising the spatial audio signal direction index value, a grid circle index value (502); determining from the grid circle index value a low direction index value (505) and a high direction index value (507); and determining an elevation index value and an azimuth index value based on the grid circle index value, the low direction index value, the high direction index value and the spatial audio signal direction index value (509).

### FIELD

The present application relates to apparatus and methods for spatial audio parameter decoding, but not exclusively for time-frequency domain direction related parameter decoding for an audio decoder.

### BACKGROUND

The immersive voice and audio services (IVAS) codec is an extension of the 3GPP EVS (enhanced voice services) codec and intended for new immersive voice and audio services over 4G/5G. Such immersive services include, e.g., immersive voice and audio for virtual reality (VR). The multi-purpose audio codec is expected to handle the encoding, decoding and rendering of speech, music and generic audio. It is expected to support a variety of input formats, such as channel-based and scene-based inputs. It is also expected to operate with low latency to enable conversational services as well as support high error robustness under various transmission conditions.

Metadata-assisted spatial audio (MASA) is one input format proposed for IVAS. It uses audio signal(s) together with corresponding spatial metadata. The spatial metadata comprises parameters which define the spatial aspects of the audio signals and which may contain for example, directions and direct-to-total energy ratios in frequency bands. The MASA stream can, for example, be obtained by capturing spatial audio with microphones of a suitable capture device. For example a mobile device comprising multiple microphones may be configured to capture microphone signals where the set of spatial metadata can be estimated based on the captured microphone signals. The MASA stream can be obtained also from other sources, such as specific spatial audio microphones (such as Ambisonics), studio mixes (for example, a 5.1 audio channel mix) or other content by means of a suitable format conversion.

### SUMMARY

There is provided according to an apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the apparatus comprising means for: obtaining a spatial audio signal direction index value; estimating, by application of a defined polynomial comprising the spatial audio signal direction index value, a grid circle index value; determining from the grid circle index value a low direction index value and a high direction index value; and determining an elevation index value and an azimuth index value based on the grid circle index value, the low direction index value, the high direction index value and the spatial audio signal direction index value.

The means for estimating, by application of a defined polynomial comprising the spatial audio signal direction index value, a grid circle index value may be for obtaining polynomial coefficients, wherein the polynomial coefficients within the polynomial cause the polynomial to approximate a function of the cumulative index value as function of the grid circle index value.

The means may be for obtaining a quantization or coding index value configured to define the maximum number of points within the spherical grid and the means for obtaining polynomial coefficients may be for obtaining polynomial coefficients based on the quantization or coding index value.

The means for estimating, by application of a defined polynomial comprising the spatial audio signal direction index value, a grid circle index value may be for: solving the defined polynomial, wherein the solution is the grid circle index value; and verifying the grid circle index is within a grid circle range defined by the quantization or coding index value.

The defined polynomial may be one of: a nth order polynomial, where n is greater than two; a second order polynomial; and a linear by pieces polynomial.

The means for determining an elevation index value and an azimuth index value based on the grid circle index value, the low direction index value, the high direction index value and the spatial audio signal direction index value may be for: determining whether the spatial audio signal direction index value is between the low direction index value and a high direction index value; and based on whether the spatial audio signal direction index value is between the low direction index value and a high direction index value generating an elevation index value based on the grid circle index value where the spatial audio signal direction index value is between the low direction index value and a high direction index value and determining or otherwise correcting the grid circle index value and redetermining the low direction index value and the high direction index value based on the corrected grid circle index value before redetermining whether the spatial audio signal direction index value is between the redetermined low direction index value and redetermined high direction index value.

The means for determining an elevation index value and an azimuth index value based on the grid circle index value, the low direction index value, the high direction index value and the spatial audio signal direction index value may be for: determining whether the spatial audio signal direction index value is between the low direction index value and a high direction index value; and based on the determining: determining, where the spatial audio signal direction index value is between the low direction index value and a high direction index value, the elevation is a positive elevation, the elevation index value is a grid circle index value divided by two rounded down and the azimuth index value is based on a difference between the spatial audio signal direction index value and the low direction index value; determining, where the spatial audio signal direction index value is between the high direction index value and a combination of the high direction index value and a number of grid points on the circle identified by the grid circle index value, the elevation is a negative elevation, the elevation index value is a grid circle index value divided by two rounded down and the azimuth index value is based on a difference between the spatial audio signal direction index value and the high direction index value; and setting the grid circle index value as a value lower, where the spatial audio signal direction index value is less than the low direction index value or otherwise setting the grid circle index value as a value higher, where the spatial audio signal direction index value is more than the combination the high direction index value and a number of grid points on the circle identified by the grid circle index value, and redetermining the low direction index value and the high direction index value based on the set grid circle index value before redetermining whether the spatial audio signal direction index value is between the redetermined low direction index value and redetermined high direction index value.

The means may be further for: determining an elevation value from the elevation index value; and determining an azimuth value from the azimuth index value.

According to a second aspect there is provided a method for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the method comprising: obtaining a spatial audio signal direction index value; estimating, by application of a defined polynomial comprising the spatial audio signal direction index value, a grid circle index value; determining from the grid circle index value a low direction index value and a high direction index value; and determining an elevation index value and an azimuth index value based on the grid circle index value, the low direction index value, the high direction index value and the spatial audio signal direction index value.

Estimating, by application of a defined polynomial comprising the spatial audio signal direction index value, a grid circle index value may comprise obtaining polynomial coefficients, wherein the polynomial coefficients within the polynomial cause the polynomial to approximate a function of the cumulative index value as function of the grid circle index value.

The method may further comprise obtaining a quantization or coding index value configured to define the maximum number of points within the spherical grid and obtaining polynomial coefficients may comprise obtaining polynomial coefficients based on the quantization or coding index value.

Estimating, by application of a defined polynomial comprising the spatial audio signal direction index value, a grid circle index value may comprise: solving the defined polynomial, wherein the solution is the grid circle index value; and verifying the grid circle index is within a grid circle range defined by the quantization or coding index value.

The defined polynomial may be one of: a nth order polynomial, where n is greater than two; a second order polynomial; and a linear by pieces polynomial.

Determining an elevation index value and an azimuth index value based on the grid circle index value, the low direction index value, the high direction index value and the spatial audio signal direction index value may comprise: determining whether the spatial audio signal direction index value is between the low direction index value and a high direction index value; and based on whether the spatial audio signal direction index value is between the low direction index value and a high direction index value generating an elevation index value based on the grid circle index value where the spatial audio signal direction index value is between the low direction index value and a high direction index value and determining or otherwise correcting the grid circle index value and redetermining the low direction index value and the high direction index value based on the corrected grid circle index value before redetermining whether the spatial audio signal direction index value is between the redetermined low direction index value and redetermined high direction index value.

Determining an elevation index value and an azimuth index value based on the grid circle index value, the low direction index value, the high direction index value and the spatial audio signal direction index value may comprise: determining whether the spatial audio signal direction index value is between the low direction index value and a high direction index value; and based on the determining: determining, where the spatial audio signal direction index value is between the low direction index value and a high direction index value, the elevation is a positive elevation, the elevation index value is a grid circle index value divided by two rounded down and the azimuth index value is based on a difference between the spatial audio signal direction index value and the low direction index value; determining, where the spatial audio signal direction index value is between the high direction index value and a combination of the high direction index value and a number of grid points on the circle identified by the grid circle index value, the elevation is a negative elevation, the elevation index value is a grid circle index value divided by two rounded down and the azimuth index value is based on a difference between the spatial audio signal direction index value and the high direction index value; and setting the grid circle index value as a value lower, where the spatial audio signal direction index value is less than the low direction index value or otherwise setting the grid circle index value as a value higher, where the spatial audio signal direction index value is more than the combination the high direction index value and a number of grid points on the circle identified by the grid circle index value, and redetermining the low direction index value and the high direction index value based on the set grid circle index value before redetermining whether the spatial audio signal direction index value is between the redetermined low direction index value and redetermined high direction index value.

The method may comprise: determining an elevation value from the elevation index value; and determining an azimuth value from the azimuth index value.

According to a third aspect there is provided an apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the apparatus comprising at least one processor and at least one memory including a computer program code, the at least one memory and the computer program code configured to, with the at least one processor, cause the apparatus at least to: obtain a spatial audio signal direction index value; estimate, by application of a defined polynomial comprising the spatial audio signal direction index value, a grid circle index value; determine from the grid circle index value a low direction index value and a high direction index value; and determine an elevation index value and an azimuth index value based on the grid circle index value, the low direction index value, the high direction index value and the spatial audio signal direction index value.

The apparatus caused to estimate, by application of a defined polynomial comprising the spatial audio signal direction index value, a grid circle index value may be caused to obtain polynomial coefficients, wherein the polynomial coefficients within the polynomial cause the polynomial to approximate a function of the cumulative index value as function of the grid circle index value.

The apparatus may be caused to obtain a quantization or coding index value configured to define the maximum number of points within the spherical grid and the apparatus caused to obtain polynomial coefficients may be caused to obtain polynomial coefficients based on the quantization or coding index value.

The apparatus caused to estimate, by application of a defined polynomial comprising the spatial audio signal direction index value, a grid circle index value may be caused to: solve the defined polynomial, wherein the solution is the grid circle index value; and verify the grid circle index is within a grid circle range defined by the quantization or coding index value.

The defined polynomial may be one of: a nth order polynomial, where n is greater than two; a second order polynomial; and a linear by pieces polynomial.

The apparatus caused to determine an elevation index value and an azimuth index value based on the grid circle index value, the low direction index value, the high direction index value and the spatial audio signal direction index value may be caused to: determine whether the spatial audio signal direction index value is between the low direction index value and a high direction index value; and based on whether the spatial audio signal direction index value is between the low direction index value and a high direction index value generate an elevation index value based on the grid circle index value where the spatial audio signal direction index value is between the low direction index value and a high direction index value and determine or otherwise correct the grid circle index value and redetermine the low direction index value and the high direction index value based on the corrected grid circle index value before redetermining whether the spatial audio signal direction index value is between the redetermined low direction index value and redetermined high direction index value.

The apparatus caused to determine an elevation index value and an azimuth index value based on the grid circle index value, the low direction index value, the high direction index value and the spatial audio signal direction index value may be caused to: determine whether the spatial audio signal direction index value is between the low direction index value and a high direction index value; and based on the determining: determine, where the spatial audio signal direction index value is between the low direction index value and a high direction index value, the elevation is a positive elevation, the elevation index value is a grid circle index value divided by two rounded down and the azimuth index value is based on a difference between the spatial audio signal direction index value and the low direction index value; determine, where the spatial audio signal direction index value is between the high direction index value and a combination of the high direction index value and a number of grid points on the circle identified by the grid circle index value, the elevation is a negative elevation, the elevation index value is a grid circle index value divided by two rounded down and the azimuth index value is based on a difference between the spatial audio signal direction index value and the high direction index value; and set the grid circle index value as a value lower, where the spatial audio signal direction index value is less than the low direction index value or otherwise set the grid circle index value as a value higher, where the spatial audio signal direction index value is more than the combination the high direction index value and a number of grid points on the circle identified by the grid circle index value, and redetermine the low direction index value and the high direction index value based on the set grid circle index value before redetermining whether the spatial audio signal direction index value is between the redetermined low direction index value and redetermined high direction index value.

The apparatus may be further caused to: determine an elevation value from the elevation index value; and determine an azimuth value from the azimuth index value.

According to a fourth aspect there is provided an apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the apparatus comprising: means for obtaining a spatial audio signal direction index value; means for estimating, by application of a defined polynomial comprising the spatial audio signal direction index value, a grid circle index value; means for determining from the grid circle index value a low direction index value and a high direction index value; and means for determining an elevation index value and an azimuth index value based on the grid circle index value, the low direction index value, the high direction index value and the spatial audio signal direction index value.

According to a fifth aspect there is provided a computer program comprising instructions [or a computer readable medium comprising program instructions] for causing an apparatus to perform at least the following: obtaining a spatial audio signal direction index value, the direction index representing a point in a spherical grid generated by covering a sphere with smaller spheres, wherein the centres of the smaller spheres define points of the spherical grid the points arranged substantially equidistant from each other on circles of constant elevation; estimating, by application of a defined polynomial comprising the spatial audio signal direction index value, a grid circle index value; determining from the grid circle index value a low direction index value and a high direction index value; and determining an elevation index value and an azimuth index value based on the grid circle index value, the low direction index value, the high direction index value and the spatial audio signal direction index value.

According to a sixth aspect there is provided a non-transitory computer readable medium comprising program instructions for causing an apparatus to perform at least the following: obtaining a spatial audio signal direction index value, the direction index representing a point in a spherical grid generated by covering a sphere with smaller spheres, wherein the centres of the smaller spheres define points of the spherical grid the points arranged substantially equidistant from each other on circles of constant elevation; estimating, by application of a defined polynomial comprising the spatial audio signal direction index value, a grid circle index value; determining from the grid circle index value a low direction index value and a high direction index value; and determining an elevation index value and an azimuth index value based on the grid circle index value, the low direction index value, the high direction index value and the spatial audio signal direction index value.

According to a seventh aspect there is provided an apparatus comprising: obtaining circuitry configured to obtain a spatial audio signal direction index value, the direction index representing a point in a spherical grid generated by covering a sphere with smaller spheres, wherein the centres of the smaller spheres define points of the spherical grid the points arranged substantially equidistant from each other on circles of constant elevation; estimating circuitry configured to estimate, by application of a defined polynomial comprising the spatial audio signal direction index value, a grid circle index value; determining circuitry configured to determine from the grid circle index value a low direction index value and a high direction index value; and determining circuitry configured to determine an elevation index value and an azimuth index value based on the grid circle index value, the low direction index value, the high direction index value and the spatial audio signal direction index value.

According to an eighth aspect there is provided a computer readable medium comprising program instructions for causing an apparatus to perform at least the following: obtaining a spatial audio signal direction index value, the direction index representing a point in a spherical grid generated by covering a sphere with smaller spheres, wherein the centres of the smaller spheres define points of the spherical grid the points arranged substantially equidistant from each other on circles of constant elevation; estimating, by application of a defined polynomial comprising the spatial audio signal direction index value, a grid circle index value; determining from the grid circle index value a low direction index value and a high direction index value; and determining an elevation index value and an azimuth index value based on the grid circle index value, the low direction index value, the high direction index value and the spatial audio signal direction index value.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically the analysis processor as shown in FIG. 1 according to some embodiments;

FIG. 3 shows schematically the metadata encoder/quantizer as shown in FIG. 1 according to some embodiments;

FIG. 4 shows schematically the metadata extractor as shown in FIG. 1 according to some embodiments;

FIG. 5 shows schematically the direction index to direction parameter converter as shown in FIG. 4 according to some embodiments;

FIGS. 6a to 6c show schematically example sphere location configurations as used in the metadata encoder/quantizer and metadata extractor as shown in FIGS. 3 to 5 according to some embodiments;

FIG. 7 shows a flow diagram of the operation of the system as shown in FIG. 1 according to some embodiments;

FIG. 8 shows a flow diagram of an example operation of the analysis processor shown in FIG. 2 according to some embodiments;

FIG. 9 shows a flow diagram of an example operation of the metadata encoder/quantizer for generating the direction index as shown in FIG. 3 according to some embodiments;

FIG. 10 shows a flow diagram of an example operation of converting direction parameter to direction index based on sphere positioning according to some embodiments;

FIG. 11 shows a flow diagram of an example operation of converting a direction index to a quantized direction parameter according to some embodiments;

FIG. 12 shows a flow diagram of determining elevation and azimuth index values from a direction index in further detail according to some embodiments; and

FIG. 13 shows schematically an example device suitable for implementing the apparatus shown.

### EMBODIMENTS OF THE APPLICATION

The following describes in further detail suitable apparatus and possible mechanisms for the decoding of parametric spatial audio streams comprising transport audio signals and spatial metadata.

As discussed above Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction a direct-to-total ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example a reasonable design choice which is able to produce a good quality output is one where the spatial metadata comprises one or more directions for each time-frequency subframe (and associated with each direction direct-to-total ratios, spread coherence, distance values etc) are determined.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

Encoding and quantizing (MASA) spatial metadata is known, for example, GB published application GB2590913 deals with grouping and reduction of spatial metadata to reduce the number of directions according to the bit rate requirements based on the input data characteristics.

Furthermore the encoding of spatial directions as indices representing points on a spherical grid defining equidistant points on a sphere is known, for example PCT application number PCT/EP2017/078948 shows such a mechanism for encoding the direction in the form of an elevation and azimuth value as an index which can be decoded by a suitable decoder and provide a quantized elevation and azimuth value.

Such mechanisms form the index and deindex employing a computationally complex loop by calculating and comparing with the offset index for each circle on the sphere. The embodiments as described herein attempt to reduce the complexity of the IVAS code where the MASA format can be used (or more generally the complexity of the code used to encode and decode the audio signals). In some embodiments this reduction in coding complexity is beneficial for the MASA format usage in the IVAS codec, as well as in other use cases for MASA.

In some embodiments the apparatus and methods aim to reduce by 3 times the complexity of the deindexing process by modelling the offset index values and using them as a starting point for the deindexing search.

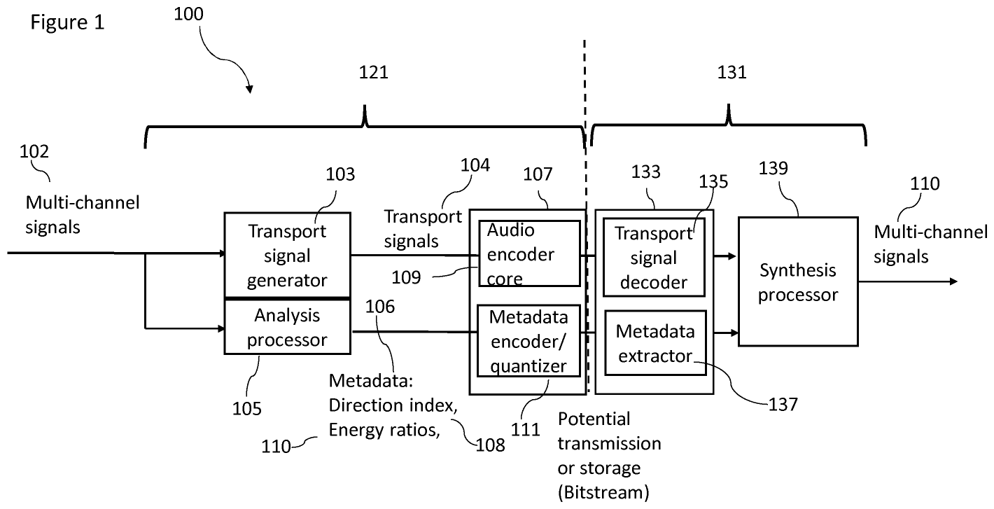

With respect to FIG. 1 an example apparatus and system for implementing embodiments of the application is shown. The system 100 is shown with an ‘analysis’ part 121 and a ‘synthesis’ part 131. The ‘analysis’ part 121 is the part from receiving the multi-channel signals up to an encoding of the spatial metadata and transport signal and the ‘synthesis’ part 131 is the part from a decoding of the encoded spatial metadata and transport signal to the presentation of the re-generated signal (for example in multi-channel loudspeaker form).

In the following description the ‘analysis’ part 121 is described as a series of parts however in some embodiments the part may be implemented as functions within the same functional apparatus or part. In other words in some embodiments the ‘analysis’ part 121 is an encoder comprising at least one of the transport signal generator or analysis processor as described hereafter.

The input to the system 100 and the ‘analysis’ part 121 is the multi-channel signals 102. The ‘analysis’ part 121 may comprise a transport signal generator 103, analysis processor 105, and encoder 107. In the following examples a microphone channel signal input is described, which can be two or more microphones integrated or connected onto a mobile device (e.g., a smartphone). However any suitable input (or synthetic multi-channel) format may be implemented in other embodiments. For example other suitable audio signals format inputs could be microphone arrays, e.g., B-format microphone, planar microphone array or Eigenmike, Ambisonic signals, e.g., first-order Ambisonics (FOA), higher-order Ambisonics (HOA), loudspeaker surround mix and/or objects, artificially created spatial mix, e.g., from audio or VR teleconference bridge, or combinations of the above.

The multi-channel signals are passed to a transport signal generator 103 and to an analysis processor 105.

In some embodiments the transport signal generator 103 is configured to receive the multi-channel signals and generate a suitable audio signal format for encoding. The transport signal generator 103 can for example generate a stereo or mono audio signal. The transport audio signals generated by the transport signal generator can be any known format. For example when the input is one where the audio signals input are mobile phone microphone array audio signals, the transport signal generator 103 can be configured to select a left-right microphone pair, and apply any suitable processing to the audio signal pair, such as automatic gain control, microphone noise removal, wind noise removal, and equalization. In some embodiments when the input is a first order Ambisonic/higher order Ambisonic (FOA/HOA) signal, the transport signal generator can be configured to formulate directional beam signals towards left and right directions, such as two opposing cardioid signals. Additionally in some embodiments when the input is a loudspeaker surround mix and/or objects, then the transport signal generator 103 can be configured to generate a downmix signal that combines left side channels to a left downmix channel, combines right side channels to a right downmix channel and adds centre channels to both transport channels with a suitable gain.

In some embodiments the transport signal generator is bypassed (or in other words is optional). For example, in some situations where the analysis and synthesis occur at the same device at a single processing step, without intermediate processing there is no transport signal generation and the input audio signals are passed unprocessed. The number of transport channels generated can be any suitable number.

The output of the transport signal generator 103 can be passed to an encoder 107.

In some embodiments the analysis processor 105 is also configured to receive the multi-channel signals and analyse the signals to produce the spatial metadata 106 associated with the multi-channel signals and thus associated with the transport signals 104. In some embodiments the spatial metadata associated with the audio signals may be a provided to the encoder as a separate bit-stream. In some embodiments the multichannel signals 102 input comprises spatial metadata and this is passed directly to the encoder 107.

The analysis processor 105 may be configured to generate the spatial metadata parameters which may comprise, for each time-frequency analysis interval, at least one direction index parameter 108 and at least one energy ratio parameter 110 (and in some embodiments other parameters such as described earlier and of which a non-exhaustive list includes number of directions, surround coherence, diffuse-to-total energy ratio, remainder-to-total energy ratio, a spread coherence parameter, and distance parameter). The direction index parameter may represent an index identifying as discussed in further detail below a direction in spherical co-ordinates denoted as azimuth φ(k,n) and elevation θ(k,n). Where the values of k and n define the frequency and time indices. In the following examples the frequency and time indices are removed for clarity reasons.

In some embodiments the number of the spatial metadata parameters may differ from time-frequency tile to time-frequency tile. Thus for example in band X all of the spatial metadata parameters are obtained (generated) and transmitted, whereas in band Y only one of the spatial metadata parameters is obtained and transmitted, and furthermore in band Z no parameters are obtained or transmitted. A practical example of this may be that for some time-frequency tiles corresponding to the highest frequency band some of the spatial metadata parameters are not required for perceptual reasons. The spatial metadata 106 may be passed to an encoder 107.

In some embodiments the analysis processor 105 is configured to apply a time-frequency transform for the input signals. Then, for example, in time-frequency tiles when the input is a mobile phone microphone array, the analysis processor could be configured to estimate delay-values between microphone pairs that maximize the inter-microphone correlation. Then based on these delay values the analysis processor may be configured to formulate a corresponding direction value for the spatial metadata. Furthermore the analysis processor may be configured to formulate a direct-to-total ratio parameter based on the correlation value.

In some embodiments, for example where the input is a FOA signal, the analysis processor 105 can be configured to determine an intensity vector. The analysis processor may then be configured to determine a direction parameter value for the spatial metadata based on the intensity vector. A diffuse-to-total ratio can then be determined, from which a direct-to-total ratio parameter value for the spatial metadata can be determined. This analysis method is known in the literature as Directional Audio Coding (DirAC).

In some examples, for example where the input is a HOA signal, the analysis processor 105 can be configured to divide the HOA signal into multiple sectors, in each of which the method above is utilized. This sector-based method is known in the literature as higher order DirAC (HO-DirAC). In these examples, there is more than one simultaneous direction parameter value per time-frequency tile corresponding to the multiple sectors.

Additionally in some embodiments where the input is a loudspeaker surround mix and/or audio object(s) based signal, the analysis processor can be configured to convert the signal into a FOA/HOA signal(s) format and to obtain direction and direct-to-total ratio parameter values as above.

The analysis processor 105 can as described above be configured to generate metadata parameters for the MASA format stream. The metadata parameters are typically generated in the time-frequency (TF) domain and produce parameters for each time-frequency tile. For the following examples and embodiments, it can be beneficial to understand how the number of TF-tiles, i.e., the TF-resolution, may be adjusted for metadata generation.

Various other methods for generating spatial metadata sets are known and can be implemented in some embodiments. Thus in summary the output of the analysis processor 105 is spatial metadata determined in frequency bands (TF tiles). The spatial metadata may involve directions and ratios in frequency bands but may also have any of the metadata types listed in the background section (or any other).

The transport audio signals 104 and the spatial metadata 106 are passed to the encoder 107.

The encoder 107 may comprise an audio encoder core 109 which is configured to receive the transport audio signals 104 and generate a suitable encoding of these audio signals. The encoder 107 can in some embodiments be a computer (running suitable software stored on memory and on at least one processor), or alternatively a specific device utilizing, for example, FPGAs or ASICs. The audio encoding may be implemented using any suitable scheme.

The encoder 107 may furthermore comprise a spatial metadata encoder/quantizer 111 which is configured to receive the spatial metadata and output an encoded or compressed form of the information. In some embodiments the encoder 107 may further interleave, multiplex to a single data stream or embed the spatial metadata within encoded downmix signals before transmission or storage shown in FIG. 1 by the dashed line. The multiplexing may be implemented using any suitable scheme. In some embodiments the spatial metadata encoder/quantizer 111 comprises a suitable index decoder configured to identify from the direction index the direction parameters which then can be encoded using a similar or fewer number of bits (and may employ a similar index based encoding and/or quantizing as shown herein).

In some embodiments the transport signal generator 103 and/or analysis processor 105 may be located on a separate device (or otherwise separate) from the encoder 107. For example in such embodiments the spatial metadata (and associated non-spatial metadata) parameters associated with the audio signals may be a provided to the encoder as a separate bit-stream.

In some embodiments the transport signal generator 103 and/or analysis processor 105 may be part of the encoder 107, i.e., located inside of the encoder and be on a same device.

The data stream is passed to the “Decoder”. The “Decoder” decodes (and possibly demultiplexes) the data stream into “Transport audio signals” and “Spatial metadata”, which are forwarded to the “Synthesis processor”.

In the following description the ‘synthesis’ part 131 is described as a series of parts however in some embodiments the part may be implemented as functions within the same functional apparatus or part.

In the decoder side, the received or retrieved data (stream) may be received by a decoder/demultiplexer 133. The decoder/demultiplexer 133 may demultiplex the encoded streams and pass the audio encoded stream to a transport signal decoder 135 which is configured to decode the audio signals to obtain the transport audio signals. Similarly the decoder/demultiplexer 133 may comprise a metadata extractor 137 which is configured to receive the encoded spatial metadata (for example a direction index representing a direction parameter value) and generate spatial metadata.

The decoder/demultiplexer 133 can in some embodiments be a computer (running suitable software stored on memory and on at least one processor), or alternatively a specific device utilizing, for example, FPGAs or ASICs.

The decoded metadata and transport audio signals may be passed to a synthesis processor 139.

The system 100 ‘synthesis’ part 131 further shows a synthesis processor 139 configured to receive the transport audio signal and the spatial metadata and re-creates in any suitable format a synthesized spatial audio in the form of multi-channel signals 140 (these may be multichannel loudspeaker format or in some embodiments any suitable output format such as binaural or Ambisonics signals, depending on the use case) based on the transport signals and the spatial metadata.

The synthesis processor 139 thus creates the output audio signals, e.g., multichannel loudspeaker signals or binaural signals based on any suitable known method. This is not explained here in further detail. However, as a simplified example, the rendering can be performed for loudspeaker output according to any of the following methods. For example the transport audio signals can be divided to direct and ambient streams based on the direct-to-total and diffuse-to-total energy ratios. The direct stream can then be rendered based on the direction parameter(s) using amplitude panning. The ambient stream can furthermore be rendered using decorrelation. The direct and the ambient streams can then be combined.

The output signals can be reproduced using a multichannel loudspeaker setup or headphones which may be head-tracked.

It should be noted that the processing blocks of FIG. 1 can be located in same or different processing entities. For example, in some embodiments, microphone signals from a mobile device are processed with a spatial audio capture system (containing the analysis processor and the transport signal generator), and the resulting spatial metadata and transport audio signals (e.g., in the form of a MASA stream) are forwarded to an encoder (e.g., an IVAS encoder), which contains the encoder. In other embodiments, input signals (e.g., 5.1 channel audio signals) are directly forwarded to an encoder (e.g., an IVAS encoder), which contains the analysis processor, the transport signal generator, and the encoder.

In some embodiments there can be two (or more) input audio signals, where the first audio signal is processed by the apparatus shown in FIG. 1 (resulting in data as an input for the encoder) and the second audio signal is directly forwarded to an encoder (e.g., an IVAS encoder), which contains the analysis processor, the transport signal generator, and the encoder. The audio input signals may then be encoded in the encoder independently or they may, e.g., be combined in the parametric domain according to what may be called, e.g., MASA mixing.

In some embodiments there may be a synthesis part which comprises separate decoder and synthesis processor entities or apparatus, or the synthesis part can comprise a single entity which comprises both the decoder and the synthesis processor. In some embodiments, the decoder block may process in parallel more than one incoming data stream. In the application the term synthesis processor may be interpreted as an internal or external renderer.

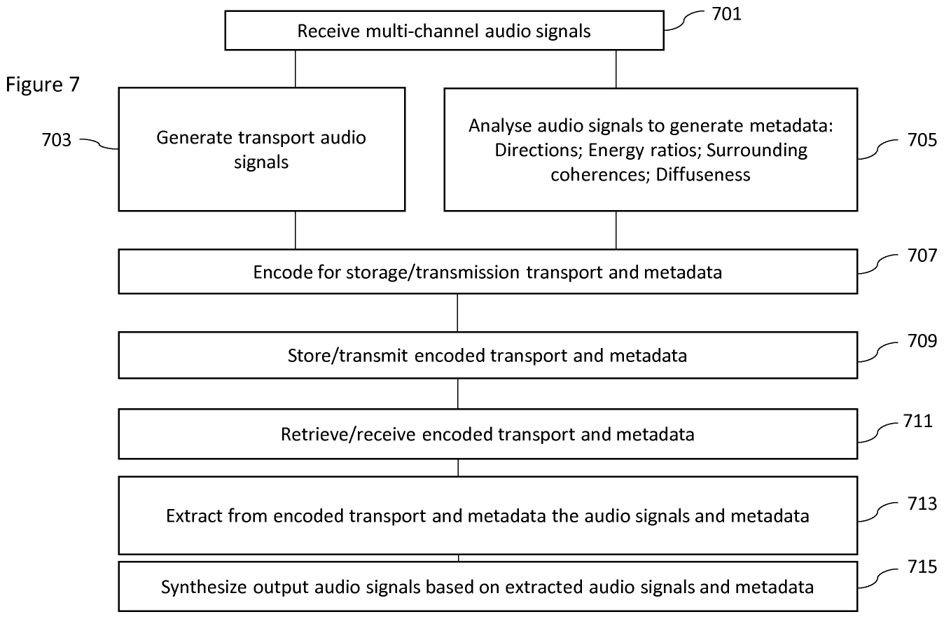

With respect to FIG. 7 an example flow diagram of the operation of the system as shown in FIG. 1 is shown.

First the system (analysis part) is configured to receive multi-channel or suitable audio signals as shown in FIG. 7 by step 701.

Then the system (analysis part) is configured to generate transport audio signals (for example by employing a downmix of the multi-channel signals) as shown in FIG. 7 by step 703.

Also the system (analysis part) is configured to analyse signals to generate metadata such as direction parameters; energy ratio parameters; diffuseness parameters and coherence parameters as shown in FIG. 7 by step 705.

The system is then configured to encode for storage/transmission the transport audio signal and metadata as shown in FIG. 7 by step 707.

After this the system may store/transmit the encoded transport audio signal and metadata as shown in FIG. 7 by step 709.

The system may retrieve/receive the encoded transport audio signals and metadata as shown in FIG. 7 by step 711.

Then the system is configured to extract the transport audio signals and metadata from encoded transport audio signals and metadata parameters, for example demultiplex and decode the encoded transport audio signals and metadata parameters, as shown in FIG. 7 by step 713.

The system (synthesis part) is configured to generate or synthesize an output multi-channel audio signal based on extracted transport audio signals and metadata as shown in FIG. 7 by step 715.

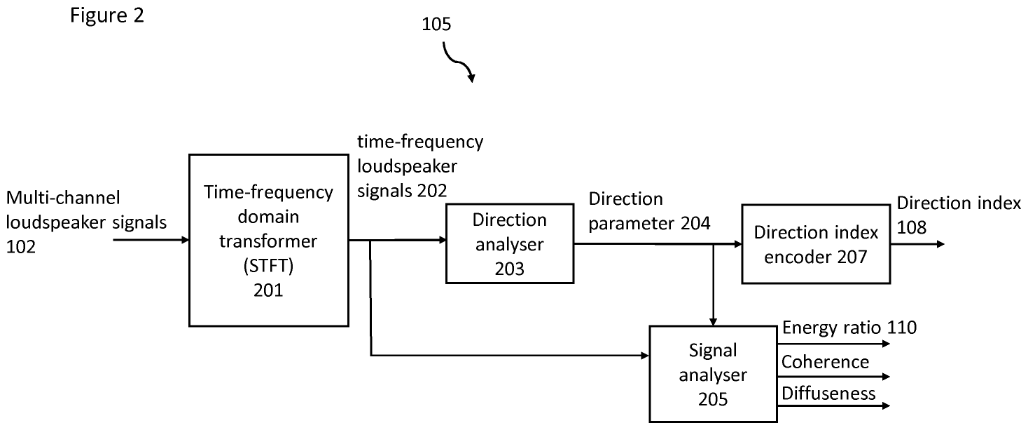

With respect to FIG. 2 an example analysis processor 105 (as shown in FIG. 1) according to some embodiments is described in further detail. The analysis processor 105 in some embodiments comprises a time-frequency domain transformer 201.

In some embodiments the time-frequency domain transformer 201 is configured to receive the multi-channel signals 102 and apply a suitable time to frequency domain transform such as a Short Time Fourier Transform (STFT) in order to convert the input time domain signals into a suitable time-frequency signals. These time-frequency signals may be passed to a direction analyser 203 and to a signal analyser 205.

Thus for example the time-frequency signals 202 may be represented in the time-frequency domain representation by

sᵢ(b,n),

where b is the frequency bin index and n is the frame index and i is the channel index. In another expression, n can be considered as a time index with a lower sampling rate than that of the original time-domain signals. These frequency bins can be grouped into subbands that group one or more of the bins into a band index k=0, . . . , K−1. Each subband k has a lowest bin b_{k,low} and a highest bin b_{k,high}, and the subband contains all bins from b_{k,low} to b_{k,high}. The widths of the subbands can approximate any suitable distribution. For example the Equivalent rectangular bandwidth (ERB) scale or the Bark scale.

In some embodiments the analysis processor 105 comprises a direction analyser 203. The direction analyser 203 may be configured to receive the time-frequency signals 202 and based on these signals estimate direction parameters 108. The direction parameters may be determined based on any audio based ‘direction’ determination.

For example in some embodiments the direction analyser 203 is configured to estimate the direction with two or more signal inputs. This represents the simplest configuration to estimate a ‘direction’, more complex processing may be performed with even more signals.

The direction analyser 203 may thus be configured to provide a direction parameter 204 such as an azimuth and elevation for each frequency band and temporal frame, denoted as azimuth φ(k,n) and elevation θ(k,n) to a direction index generator 207. The direction parameter 108 may be also be passed to a signal analyser 205.

In some embodiments the estimated direction 204 parameters may be output (and passed to an encoder) without generating the direction index 108 first as described below in further detail.

In some embodiments the analysis processor 105 comprises a signal analyser 205. The signal analyser 205 may be further configured to receive the time-frequency signals (sᵢ(b,n)) 202 from the time-frequency domain transformer 201 and the direction 108 parameters from the direction analyser 203. In some embodiments the signal analyser is configured to determine an energy ratio parameter 110. The energy ratio may be considered to be a determination of the energy of the audio signal which can be considered to arrive from a direction. The energy ratio may be a direct-to-total energy ratio r(k,n) which can be estimated from a stability measure of the directional estimate, or using any correlation measure, or any other suitable method to obtain a ratio parameter.

Furthermore the analysis processor 105 comprises a direction index generator 207. The direction index generator 207 is configured to receive or obtain the estimated direction parameters 204 and generate a direction index 108. The generation of the direction index 108 values by the direction index generator 207 is described in further detail below.

All of these are in the time-frequency domain; b is the frequency bin index, k is the frequency band index (each band potentially consists of several bins b), n is the time index, and i is the channel.

Although directions and ratios are here expressed for each time index n, in some embodiments the parameters may be combined over several time indices. Same applies for the frequency axis, as has been expressed, the direction of several frequency bins b could be expressed by one direction parameter in band k consisting of several frequency bins b. The same applies for all of the discussed spatial parameters herein.

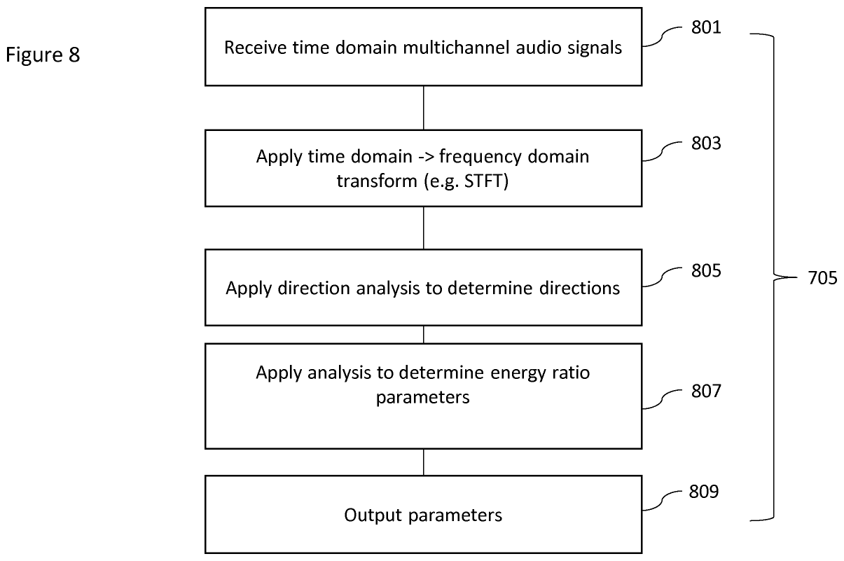

With respect to FIG. 8 a flow diagram summarising the operations of the analysis processor 105 are shown.

The first operation is one of receiving time domain multichannel (loudspeaker) audio signals as shown in FIG. 8 by step 801.

Following this is applying a time domain to frequency domain transform (e.g. STFT) to generate suitable time-frequency domain signals for analysis as shown in FIG. 8 by step 803.

Then applying direction analysis to determine direction parameters is shown in FIG. 8 by step 805.

Then applying analysis to determine energy ratio parameters is shown in FIG. 8 by step 807.

The final operation being one of outputting the determined parameters is shown in FIG. 8 by step 809.

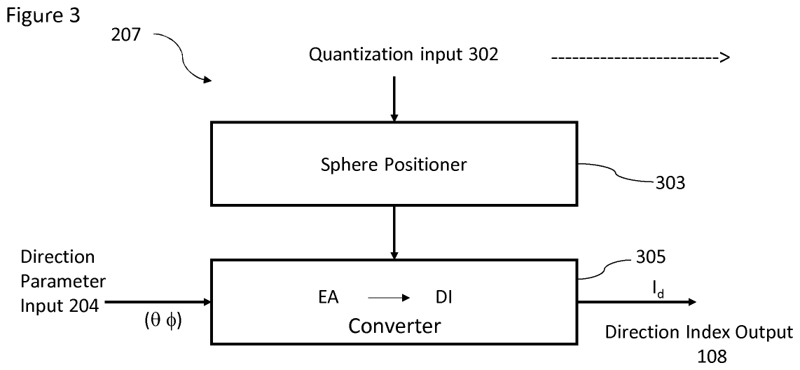

With respect to FIG. 3 an example direction index encoder or generator 207 is shown in further detail according to some embodiments.

The direction index generator or encoder 207 or direction metadata encoder in some embodiments comprises a quantization input 302. The quantization input, which may also be known as an encoding input is configured to define the granularity of spheres arranged around a reference location or position from which the direction parameter is determined. In some embodiments the quantization input is a predefined or fixed value. In some embodiments the quantization input can furthermore define a number of bits which defines the granularity.

The direction index encoder 207 in some embodiments comprises a sphere positioner 303. The sphere positioner 303 is configured to configure the arrangement of spheres based on the quantization input value. The quantization input value can for example comprise the number of bits to be used to indicate maximum number of spheres substantially spaced around the spherical grid. The proposed spherical grid uses the idea of covering a sphere with smaller spheres and considering the centres of the smaller spheres as points defining a grid of almost equidistant directions.

In the following examples the spherical grid covers the whole of a large sphere surface. However in some embodiments the spherical grid covers only a portion of the sphere surface. For example the grid can cover a hemisphere or segment of the sphere.

The quantization input value can, for example, identify that the sphere indexing is a 16 bit number which results in an index which can identify one from 65536 possible spheres. The quantization input value can furthermore identify how much of the sphere surface is to be covered by the spherical grid.

The indexing/deindexing as shown in this example occurs in the creation of and use of the spatial audio signal related metadata, however the indexing (the direction index generator) and deindexing (the direction index decoder) can in some embodiments be implemented in two places. The first, as shown herein, is the creation and use of (MASA format) metadata and the quantization and encoding of the (MASA format) metadata.

In some embodiments the sphere indexing for the creation and use of metadata can have a 16 bit index. For example the analysis processor 105 can be configured to generate the index and the IVAS coder then reads and decodes the index.

This decoding of the index, in particular, can implement the direction index decoder as described herein later using a polynomial function.

A similar process can be employed for the indexing/deindexing after a further quantization in the IVAS codec (the metadata encoder/quantizer 111 and metadata extractor 137). In some embodiments the number of bits used quantize/encode the direction in the IVAS codec is 1 to 11 bits.

The quantization inside the metadata encoder/quantizer 111 (at lower number of bits, the data from the sphere positioner 303 can in some embodiments stored as tables (number of elevation levels, i.e. circles on sphere and numbers of points on each sphere).

In some embodiments the calculations are performed only once per input file and the numbers are stored in random access memory (RAM), not as table read only memory (ROM).

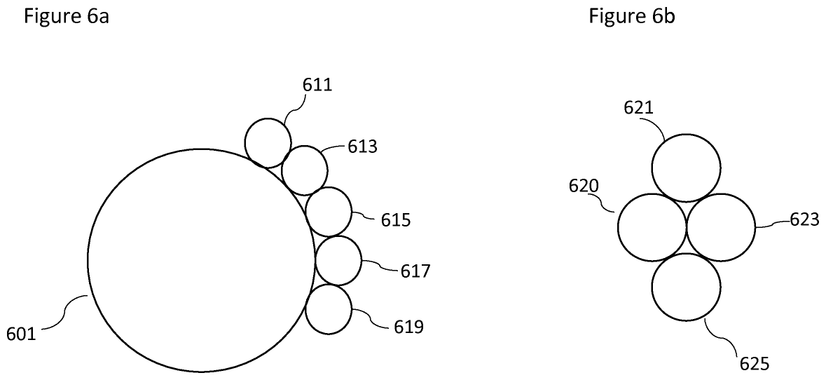

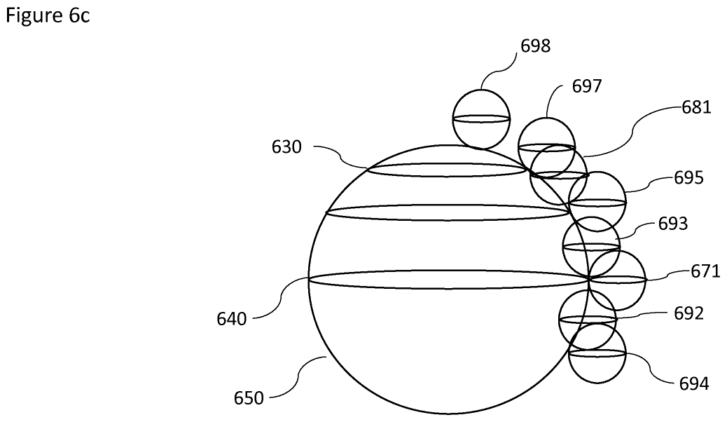

The concept as shown herein is one in which a sphere is defined relative to the reference location. The sphere can be visualised as a series of circles (or intersections) and for each circle intersection there are located at the circumference of the circle a defined number of (smaller) spheres. This is shown for example with respect to FIG. 6a to 6c. For example FIG. 6a shows an example ‘equatorial cross-section’ or a first main circle 601 which has a radius defined as the ‘main sphere radius. Also shown in FIG. 6a are the smaller spheres (shown as circle cross-sections) 611, 613, 615, 617 and 619 located such that each smaller sphere has a circumference which at one point touches the main sphere circumference and at least one further point which touches at least one further smaller sphere circumference. Thus as shown in FIG. 6a the smaller sphere 611 touches main sphere 601 and smaller sphere 613, smaller sphere 613 touches main sphere 601 and smaller spheres 611 and 615, smaller sphere 615 touches main sphere 601 and smaller spheres 613 and 617, smaller sphere 617 touches main sphere 601 and smaller spheres 615 and 619, and smaller sphere 619 touches main sphere 601 and smaller sphere 617.

FIG. 6b shows an example ‘tropical cross-section’ or further main circle 620 and the smaller spheres (shown as circle cross-sections) 621, 623, 625 located such that each smaller sphere has a circumference which at one point touches the main sphere (circle) circumference and at least one further point which touches at least one further smaller sphere circumference. Thus as shown in FIG. 6b the smaller sphere 621 touches main sphere 620 and smaller sphere 623, smaller sphere 623 touches main sphere 620 and smaller spheres 621 and 625, smaller sphere 625 touches main sphere 620 and smaller sphere 623.

FIG. 6c shows an example sphere 650 and the cross sections 630, 640 and smaller spheres (cross-sections) 681 associated with cross-section 630, smaller sphere 671 associated with cross-section 640 and other smaller spheres 692, 693, 694, 695, 697, 698. In this example only the circles with starting azimuth value at 0 are drawn.

The sphere positioner 303 thus in some embodiments be configured to perform the following operations to define the directions corresponding to the covering spheres:

Input: Quantization input (number of points on the “Equator”, n(0)=M)
Output: number of circles, Nc, and number of points on each circle, n(i), i=0,

Nc−1

| 1. | n(0) = M | | |
|---|---|---|---|
| 2. | $∝ = \frac{2 π}{n ( 0 )}$ | | |
| 3. | R(0) = 1 (radius of the circle at the Equator) | | |
| 4. | θ(0) = 0 (elevation) | | |
| 5. | $r = 2 R ( 0 ) sin ( \frac{α}{4} ) ( radius of the smaller spheres )$ | | |
| 6. | ϕ(0) = 0 | | |
| 7. | $p = arcsin ( r \frac{\sqrt{3}}{R ( 0 )} )$ | | |
| 8. | R(1) = R(0) cos p | | |
| 9. | i = 1 | | |
| 10. | While n(i − 1) > 1 | | |
| | a. | $n ( i ) = ⌊ \frac{π R ( i )}{r} ⌋ ( this is valid when r << R ( 0 ) )$ | |
| | b. | θ(i) = p · i | |
| | c. | $Δϕ ( i ) = \frac{π}{n ( i - 1 )} ( granularity of the azimuth on the circle i )$ | |
| | d. | R(i + 1) = R(i) cos((i + 1) · p) | |
| | e. | If i is odd | |
| | | i. | ${ϕ}_{0} ( i ) = \frac{Δϕ ( i )}{2} ( first azimuth value on circle i )$ |
| | f. | Else | |
| | | i. | ϕ₀(i) = 0 |

| | |
|---|---|
| g. | End if |
| h. | i = i + 1 |

| | |
|---|---|
| 11. | End while |
| 12. | Nc=i+1 |

Step 5 can be also replaced by

$$r = 2 R ( 0 ) sin ( \frac{α}{k} )$$

where the factor k controls the distribution of points along the elevation. For k=4, the elevation resolution is approximately 1 degree. For smaller k, the resolution is correspondingly smaller.

The elevation for each point on the circle i is given by the values in θ(i). For each circle above the Equator there is a corresponding circle under the Equator.

Each direction point on one circle can be indexed in increasing order with respect to the azimuth value. The index of the first point in each circle is given by an offset that can be deduced from the number of points on each circle, n(i). In order to obtain the offsets, for a considered order of the circles, the offsets are calculated as the cumulated number of points on the circles for the given order, starting with the value 0 as first offset.

One possible order of the circles could be to start with the Equator followed by the first circle above the Equator, then the first under the Equator, the second one above the Equator, and so on.

Another option is to start with the Equator, then the circle above the Equator that is at an approximate elevation of 45 degrees and then the corresponding circle under the Equator, and then the remaining circles in alternative order. This way for some simpler positioning of loudspeakers, only the first circles are used, reducing the number of bits to send the information.

Other ordering of the circles are also possible in other embodiments.

In some embodiments the spherical grid can also be generated by considering the meridian 0 instead of the Equator, or any other meridian.

The sphere positioner having determined the number of circles and the number of circles, Nc, number of points on each circle, n(i), i=0, Nc-1 and the indexing order can be configured to pass this information to an EA to DI converter 305.

The direction index encoder 207 in some embodiments comprises a direction parameter input 204. The direction parameter input 204 may define an elevation and azimuth value D=(θ,ϕ).

The transformation procedures from (elevation/azimuth) (EA) to direction index (DI) are presented in the following paragraphs. The alternative ordering of the circles is considered here.

The direction index encoder 207 comprises an elevation-azimuth to direction index (EA-DI) converter 305. The elevation-azimuth to direction index converter 305 in some embodiments is configured to receive the direction parameter input 204 and the sphere positioner information and convert the elevation-azimuth value from the direction parameter input 204 to a direction index 108 to be output.

In some embodiments the elevation-azimuth to direction index (EA-DI) converter 305 is configured to perform this conversion according to the following algorithm:

### Input:

$$( θ , ϕ ) , θ ∈ {S}_{θ} ⊂ [ - \frac{π}{2} , \frac{π}{2} ] , ϕ ∈ {S}_{ϕ} ⊂ [ 0 , 2 π ]$$

### Output: I_{d}

For a given value of Nc, the granularity, p along the elevation is known. The values θ, ϕ are from a discrete set of values, corresponding to the indexed directions. The number of point on each circle and the corresponding offset, off(i) are known.
1. Find the circle index

$$i = \{ \begin{matrix}2 \frac{θ}{p} - 1 , if θ > 0 \\ 0 , if θ = 0 \\ - 2 \frac{θ}{p} , if θ < 0\end{matrix}$$

2. Find the index of the azimuth within the circle

$$I : j = ⌊ \frac{ϕ}{Δϕ ( i ′ )} ⌋ where {i}^{′} = ⌊ \frac{θ}{p} ⌋$$

3. The direction index is I_{d}=off(i)+j

The direction index I_{d} 108 may be output.

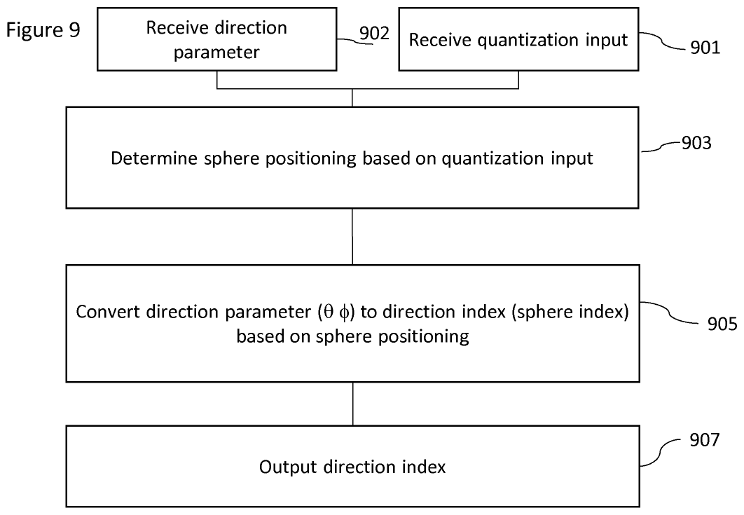

With respect to FIG. 9 an example method for generating the direction index according to some embodiments is shown.

The receiving of the quantization input is shown in FIG. 9 by step 901.

Then the method may determine sphere positioning based on the quantization input as shown in FIG. 9 by step 903.

Also the method may comprise receiving the direction parameter as shown in FIG. 9 by step 902.

Having received the direction parameter and the sphere positioning information the method may comprise converting the direction parameter to a direction index based on the sphere positioning information as shown in FIG. 9 by step 905.

The method may then output the direction index as shown in FIG. 9 by step 907.

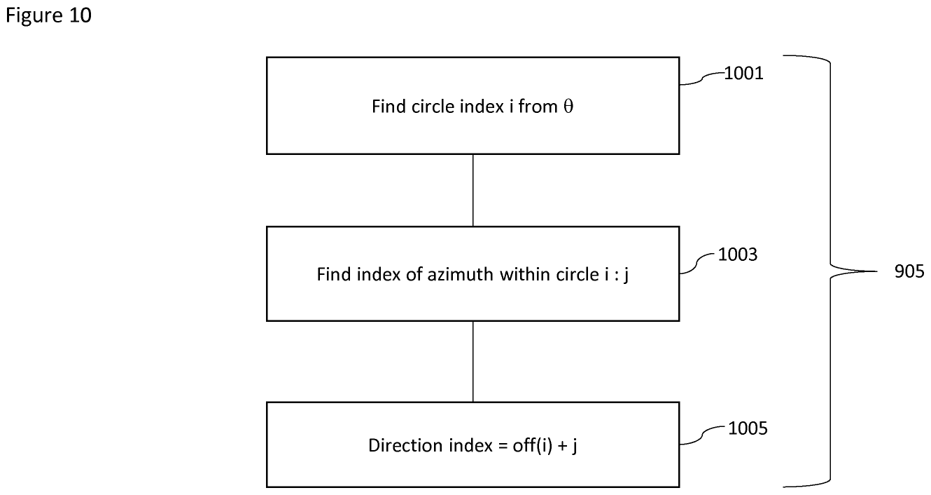

With respect to FIG. 10 an example method for converting elevation-azimuth to direction index (EA-DI), as shown in FIG. 9 by step 905, according to some embodiments is shown.

The method starts by finding the circle index i from the elevation value 0 as shown in FIG. 9 by step 901.

Having determined the circle index the index of the azimuth based on the azimuth value p is found as shown in FIG. 9 by step 903.

Having determined the circle index i and the index of the azimuth the direction is then determined by adding the value of the index of the azimuth to the offset associated with the circle index as shown in FIG. 9 by step 905.

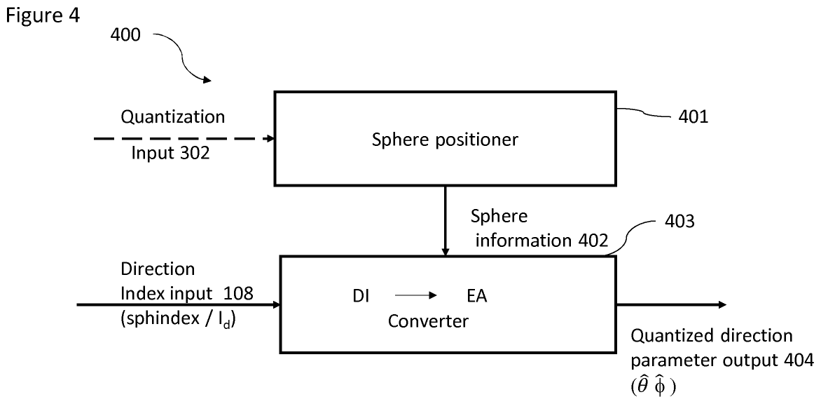

With respect to FIG. 4 an example metadata extractor 137 and specifically a direction metadata extractor 400 is shown according to some embodiments.

The direction metadata extractor 400 in some embodiments comprises a quantization input 302. This in some embodiments is passed from the metadata encoder or is otherwise agreed with the encoder. The quantization input is configured to define the granularity of spheres arranged around a reference location or position.

The direction index decoder 400 in some embodiments comprises a direction index input 108. This may be received from the direction index encoder or retrieved by any suitable means. In the following example the direction index decoder 400 can be implemented within the metadata encoder/quantizer 111 as part of an IVAS encoder (for example the metadata encoder/quantizer 111 as shown in FIG. 1). However the direction index decoder 400 can be implemented as part of the IVAS decoding process, for example within the metadata extractor 137.

The direction index decoder 400 in some embodiments comprises a sphere positioner 401. The sphere positioner 401 is configured to receive as an input the quantization input 302 and generate the sphere arrangement in the same manner as generated in the direction index encoder 207. In some embodiments the quantization input and the sphere positioner 401 is optional and the arrangement of spheres information is passed from the encoder rather than being generated in the decoder.

The direction metadata decoder 400 in some embodiments comprises a direction index to elevation-azimuth (DI-EA) converter 403. The direction index to elevation-azimuth converter 403 is configured to receive the direction index 108 and furthermore the sphere position information 402 and generate an approximate or quantized direction parameter (elevation-azimuth) output 404. In some embodiments the decoding is performed according to the method detailed hereafter.

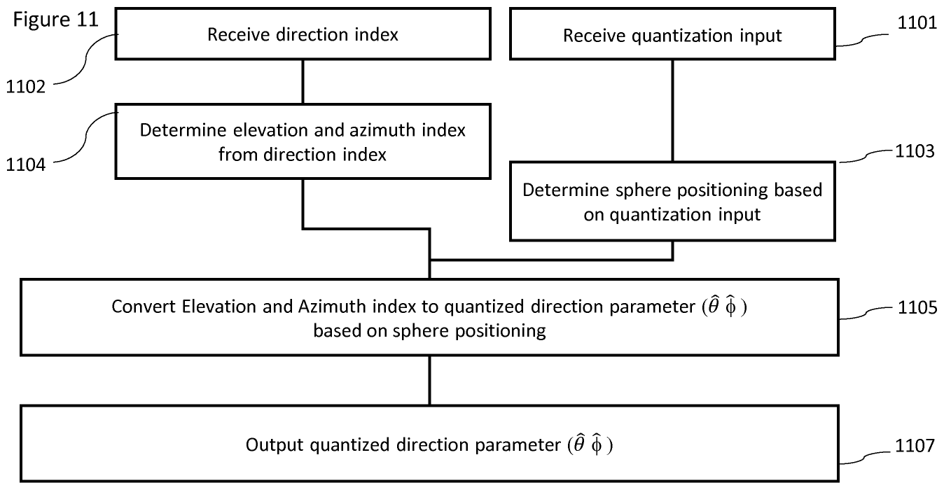

With respect to FIG. 11 an example method for decoding the direction index to generate quantized direction parameters according to some embodiments is shown.

The receiving, obtaining or otherwise determining the quantization input defining the number of bits used to encode the index is shown in FIG. 11 by step 1101.

Then the method may determine sphere positioning based on the quantization input as shown in FIG. 11 by step 1103.

Also the method may comprise receiving the direction index as shown in FIG. 11 by step 1102.

Having received the direction index (and the quantization input) the method may comprise determining an elevation index and azimuth index from the direction index as shown in FIG. 11 by step 1104.

Then having determined the elevation index and azimuth index and knowing the sphere positioning information the method is configured to convert the azimuth and elevation index values to a direction parameter in the form of a quantized direction parameter as shown in FIG. 11 by step 1105.

The method may then output the quantized direction parameter as shown in FIG. 11 by step 1107.

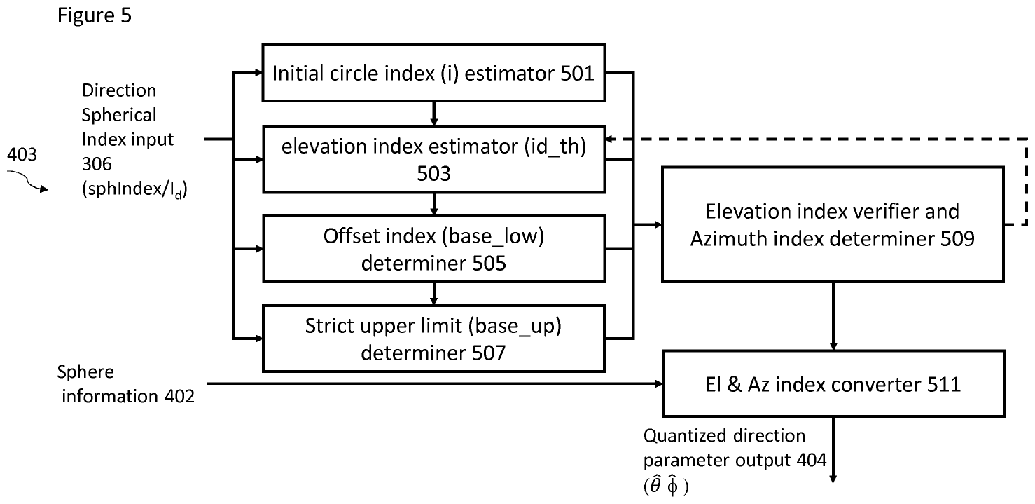

With respect to FIG. 5 an example direction index to elevation-azimuth (DI-EA) converter 403 is shown in further detail.

As shown with respect to FIG. 4 the direction index to elevation-azimuth (DI-EA) converter 403 is configured to obtain or otherwise receive as inputs the sphere information 402 and the direction spherical index input 306. In some embodiments as the quantization input 302 and sphere information 402 are dependent on each other either one of these can be used.

In these embodiments rather than explicitly calculating the cumulated number of points for each circle, there is employed a polynomial approximation for the cumulated number of points. The modelling of the spherical grid points for each circle can employ any suitable order polynomial. In the following examples a second order polynomial is employed. However a n′th order polynomial, where n is greater than two or a linear (by pieces) polynomial can in some embodiments be employed.

A second order polynomial can, as is described in the following embodiments, be used as a function of the circle index, starting from the Equator of the large sphere to the north pole. In the following embodiments only one hemisphere is considered since the circles are symmetrically places on the two hemispheres of the large sphere. In the following an example is shown where the grid is identified by a 16 bits length index and there are 122 elevation values in absolute value, corresponding to 122 circles including the Equator. Under the Equator there are 121 additional circles. The number of points n(i) on each of the 243=121*2-1 circles can be approximated as:

$$n ( i ) = {p}_{0} {i}^{2} + {p}_{1} i + {p}_{2}$$

where i=0:243 is the index of the circle starting from the Equator and alternating positive and negative elevation values.

The second order polynomial coefficients can be chosen or predetermined to approximate the offset indexes n(i) as function of the circle index. The predetermination or fitting can be implemented (offline, not in the code) such that for 16 bit index
p₀=−0.92122660347339,
p₁=504.443248254235, and
p₂=−1618.30941080194.

In these embodiments and for these values the offset indexes are the cumulated sum of the number of points on each circle in the order:
circle on Equator;
first circle on positive hemisphere;
first circle on negative hemisphere;
second circle on positive hemisphere;
and so on . . . .

In some embodiments the direction index to elevation-azimuth (DI-EA) converter 403 comprises an initial circle index (i) estimator 501. The initial circle estimator 501 is configured to estimate the index value (estim) on the circle by solving the second order equation. In the 16 bit example an estimate of “i” is the solution of the equation:

$$sphIndex = {p}_{0} {i}^{2} + {p}_{1} i + {p}_{2}$$

that is between 0 and 121, where sphIndex is the input directional index. In other words the estimated index of the circle is thus computed by solving the second order equation and checking which solution is within the closed domain 0:242. There are in total 243 circles because there are 121 circles on the positive hemisphere, 1 circle on Equator and 121 circles on the negative side. This number is for 16 bits and will differ for different number of bits, or for a different arrangement of spheres on the sphere. In some embodiments there is also the possibility to make the polynomial fitting on only the positive side, but for this the spherical index should be first divided by two.

In some embodiments the polynomial employed can be a linear polynomial approximation, which is linear by pieces

In some embodiments the direction index to elevation-azimuth (DI-EA) converter 403 comprises an elevation index (id_th) estimator 503. In some embodiments an initial elevation index value is determined from the initial circle estimate (estim) for example using the following estimator:

$$id\_th = round ( estim / 2 )$$

this is because the distribution of the circles is as described above alternating between positive and negative circles.

In some embodiments the direction index to elevation-azimuth (DI-EA) converter 403 comprises an offset index (base_low) determiner 505. The offset index determiner 505 is configured to determine or calculate or otherwise obtain the offset index, base_low, for the points on the circle corresponding to elevation of index id_th in the positive hemisphere. In some embodiments these values are predetermined and stored in a suitable memory (for example accessible as a look-up table using the elevation index value as an input).

In some embodiments the direction index to elevation-azimuth (DI-EA) converter 403 comprises a strict upper limit (base_up) determiner 507. The strict upper limit (base_up) determiner 507 is configured to obtain or determine or calculate the upper strict limit of the points on the circle corresponding to elevation of index (id_th) in the positive hemisphere. In some embodiments these values are predetermined and stored in a suitable memory (for example accessible as a look-up table using the elevation index value as an input).

In some embodiments the determination of the base_low and base_up values can be implemented by computing the numbers of points on each circle on the positive side, n_pos(i) and which can then be stored in RAM.

For example the base_low and base_up values can be calculated as base_low=n_pos[0]+2*sum_s(&n_pos[1], id_th−1); and base_up=base_low+n_pos[id_th].

The “*2” factor is based on the ordering of the spherical grid circles from the equator, first circle on positive hemisphere, first circle on the negative hemisphere, second circle on the positive hemisphere and so on.

These base_up and base_low values are the border spherical grid index values for indexes of points with positive elevation for elevation index value id_th. For the same elevation index there is an associated negative hemisphere elevation group for which the base_low is the current base_up and the base_up is increased with the number of points n_pos[id_th].

The id_th value starts from 0 and increase and the cumulated indexes (offsets) are calculated based on the stored number of points per circle.

Furthermore the direction index to elevation-azimuth (DI-EA) converter 403 comprises an elevation index verifier and azimuth index determiner 509. The elevation index verifier and azimuth index determiner 509 is configured to obtain the initial circle index value estimate i, the initial elevation index value estimate id_th, the offset index (base_low) value and the strict upper limit (base_up) value and based on these determine the elevation index and azimuth index values.

In some embodiments this can be determined if the spherical index is between the base_low and base_up values, then id_th is the elevation index, the elevation is a positive elevation (or in the positive hemisphere) and the azimuth index is the difference between the spherical index and base_low values else if the spherical index is between base_up and base_up+n(i) then id_th is the elevation index, the elevation is a negative elevation (or in the negative hemisphere) and the azimuth index is the difference between the spherical index and base_up values.

If neither of these are true then if the sphIndex index is less than the base_low value then the value of id_th is changed to id_th−1 and the offset elevation index, offset index and strict upper limit values estimated for the new value of id_th.

Else if the sphIndex index is not less than the base_low value then the value of id_th is changed to id_th+1 and the offset elevation index, offset index and strict upper limit values estimated for the new value of id_th. These changes of id_th can be shown in FIG. 5 by the control dashed line from the Elevation index verifier and Azimuth index determiner 509 and the elevation index estimator 503.

The elevation index and azimuth index values can then be passed to the elevation and azimuth index converter 511.

In some embodiments the direction index to elevation-azimuth (DI-EA) converter 403 comprises the elevation and azimuth index converter 511 which is configured to receive the elevation index and azimuth index values and the sphere information 402 and from these determine the quantized direction parameter output 404.

Although FIG. 5 shows one possible implementation where the circle index is determined or estimated directly by solving a polynomial modelling the number of grid points in the spherical grid. However it would be appreciated that the polynomial model of the points in the spherical grid can be employed in some implementations. For example in some embodiments, where there is also an alternating positive and negative elevation circle indexing, there can be implemented two additional determiners associated with the negative elevation circle offset index and strict upper limit values. In such an implementation the elevation index verifier can be implemented as a first verifier using the positive elevation circle offset index and strict upper limit values and a second verifier using the negative elevation circle offset index and strict upper limit values. The outputs of the verifiers then passes directly to an index converter.

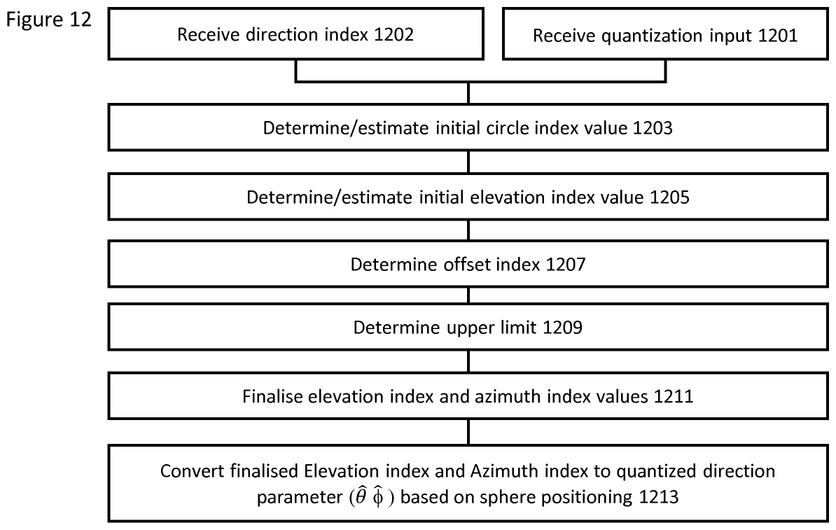

With respect to FIG. 12 is shown a flow diagram showing the operations of the direction index to elevation-azimuth (DI-EA) converter 403 shown in FIG. 5.

The direction index is received as shown in FIG. 12 by step 1202.

The quantization input is received as shown in FIG. 12 by step 1201.

The initial circle index value is determined/estimated as shown in FIG. 12 by step 1203.

The (initial) elevation index is determined/estimated as shown in FIG. 12 by step 1205.

An offset index value is determined as shown in FIG. 12 by step 1207.

Further an upper limit value is determined as shown in FIG. 12 by step 1209.

A finalised elevation index value and azimuth index value is then determined as shown in FIG. 12 by step 1211.

Then based on the finalised elevation index value and azimuth index value a quantized direction parameter (\hat{θ} \hat{ϕ}) based on sphere positioning from the quantization input is determined as shown in FIG. 12 by step 1213.

In some embodiments the operation of the direction index to elevation-azimuth (DI-EA) converter 403 according to some embodiments can be shown by the following steps for finding the elevation and azimuth indexes and consequently the elevation and azimuth indexes from the original spherical index, sphIndex is:

```
  1. Find initial estimate, estim, of “i” as the solution of the equation:
                    sphIndex = p₀ i² + p₁i + p₂
that is between 0 and 242.
  2. Calculate initial estimate of elevation index id_th = round(estim/2)
  3. Calculate the offset index, base_low, for the points on the circle
    corresponding to elevation of index “id_th” in the positive hemisphere.
  4. Calculate, base_up, the upper strict limit of the points on the circle
    corresponding to elevation of index “id_th” in the positive hemisphere.
  5. If the spherical index is between base_low and base_up,
      a. then id_th is the elevation index, the elevation is positive and the
        azimuth index is the difference between the spherical index and
        base_low
      b. Return
  6. Else
      a. If the spherical index is between base_up and base_up + n(i)
              i. then id_th is the elevation index, the elevation is negative and
                the azimuth index is the difference between the spherical index
                and base_up
            ii. Return
      b. Else
              i. If sphIndex < base_low
                  1. id_th = id_th − 1
                  2. Go to 3
            ii. Else
                  1. id_th = id_th + 1
                  2. Go to 3
          iii. End
      c. End
  7. End
```

This can for example be implemented as a C language form, with a slight change in the comparison order to reduce the number of “if else” commands, as:

```
float p[3] = {−0. 92122660347339f, 504.443248254235f, −1618.30941080194f};
float estim, estim2;
short not_ready;
unsigned short base_low, base_up;
float b2 = 2.544629907092843e+05f, div = −0.542754625316727f;
float delta;
delta = sqrtf ( b2 + 3.684906413893552 * ( p[2] − sphIndex ) );
estim = ( −p[1] + delta ) *div;
if ( estim > 0 && estim <= 243 )
{
  id_th = (short) ( estim*0.5f ) ;
}
else
{
  estim2 = ( −p[1] − delta ) *div;
  if ( estim2 > 0 && estim2 <= 243 )
  {
  id_th = (short) ( estim2*0.5f ) ;
  }
}
if ( id_th == 0 )
{
  base_low = 0;
  base_up = n [0] ;
}
else
{
  base_low = n [0] + 2 * sum_s ( &n [1], id th − 1 );
  base_up = base_low + n [id_th];
}
sign_theta = 0;
id_phi = 0;
not_ready = 1;
cnt = 0;
while (not_ready && id_th < 122)
{
  cnt++;
  if (sphIndex < base_low)
  {
    id_th = id_th − 1;
    if ( id_th == 0 )
    {
      base_low = 0;
      base_up = n [0];
    }
    Else
    {
      base_low = base_low − 2 * n [id_th − 1];
      base_up = base_low + n[id_th];
    }
    }else
    {
      if ( sphIndex >= base_up )
      {
        if ( sphIndex < base_up + n [id_th] )
        {
          id_phi = sphIndex − base_low;
          sign_theta = 1;
          not_ready = 0;
        }
        Else
        {
          id_th = id_th + 1;
          base_low = base_low + 2*n [id th − 1];
          base_up = base_low + n[id_th];
        }
      }
      Else
      {
        id_phi = sphIndex − base_low;
        sign_theta = 1;
        not_ready = 0;
    }
}
```

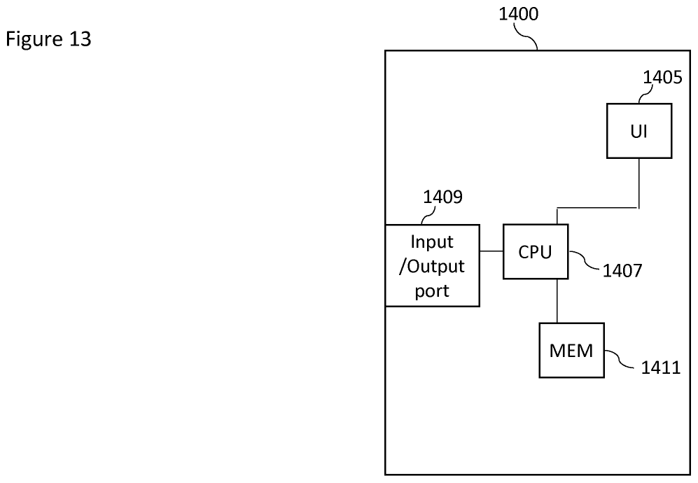

With respect to FIG. 13 an example electronic device which may be used as the analysis or synthesis device is shown. The device may be any suitable electronics device or apparatus. For example in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein, and generate a suitable audio signal format output by using the processor 1407 executing suitable code. The input/output port 1409 may be coupled to any suitable audio output for example to a multichannel speaker system and/or headphones or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-16. (canceled)

17. An apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, wherein the apparatus comprising at least one processor and at least one memory including computer program code configured to, with the at least one processor, cause the apparatus to at least to:
obtain a spatial audio signal direction index value;
estimate, by application of a defined polynomial comprising the spatial audio signal direction index value, a grid circle index value;
determine from the grid circle index value a low direction index value and a high direction index value; and
determine an elevation index value and an azimuth index value based on the grid circle index value, the low direction index value, the high direction index value and the spatial audio signal direction index value.

18. The apparatus as claimed in claim 17, wherein the apparatus configured to estimate, by application of a defined polynomial comprising the spatial audio signal direction index value, a grid circle index value is configured to obtain polynomial coefficients, wherein the polynomial coefficients within the polynomial cause the polynomial to approximate a function of the cumulative index value as function of the grid circle index value.

19. The apparatus as claimed in claim 18, wherein the apparatus configured to obtain a quantization or coding index value configured to define the maximum number of points within the spherical grid and the means for obtaining polynomial coefficients is configured to obtain polynomial coefficients based on the quantization or coding index value.

20. The apparatus as claimed in claim 19, wherein the apparatus configured to estimate, by application of a defined polynomial comprising the spatial audio signal direction index value, a grid circle index value is configured to:
solve the defined polynomial, wherein the solution is the grid circle index value; and
verify the grid circle index is within a grid circle range defined by the quantization or coding index value.

21. The apparatus as claimed in claim 17, wherein the defined polynomial is one of:
a nth order polynomial, where n is greater than two;
a second order polynomial; and
a linear by pieces polynomial.

22. The apparatus as claimed in claim 17, wherein the apparatus configured to determine an elevation index value and an azimuth index value based on the grid circle index value, the low direction index value, the high direction index value and the spatial audio signal direction index value is configured to:
determine whether the spatial audio signal direction index value is between the low direction index value and a high direction index value;
and based on whether the spatial audio signal direction index value is between the low direction index value and a high direction index value generate an elevation index value based on the grid circle index value where the spatial audio signal direction index value is between the low direction index value and a high direction index value and determine or otherwise correct the grid circle index value and redetermine the low direction index value and the high direction index value based on the corrected grid circle index value before redetermining whether the spatial audio signal direction index value is between the redetermined low direction index value and redetermined high direction index value.

23. The apparatus as claimed in claim 17, wherein the apparatus configured to determine an elevation index value and an azimuth index value based on the grid circle index value, the low direction index value, the high direction index value and the spatial audio signal direction index value is configured to:
determine whether the spatial audio signal direction index value is between the low direction index value and a high direction index value; and based on the determining:
determine, where the spatial audio signal direction index value is between the low direction index value and a high direction index value, the elevation is a positive elevation, the elevation index value is a grid circle index value divided by two rounded down and the azimuth index value is based on a difference between the spatial audio signal direction index value and the low direction index value;
determine, where the spatial audio signal direction index value is between the high direction index value and a combination of the high direction index value and a number of grid points on the circle identified by the grid circle index value, the elevation is a negative elevation, the elevation index value is a grid circle index value divided by two rounded down and the azimuth index value is based on a difference between the spatial audio signal direction index value and the high direction index value; and
set the grid circle index value as a value lower, where the spatial audio signal direction index value is less than the low direction index value or otherwise setting the grid circle index value as a value higher, where the spatial audio signal direction index value is more than the combination the high direction index value and a number of grid points on the circle identified by the grid circle index value, and redetermine the low direction index value and the high direction index value based on the set grid circle index value before redetermine whether the spatial audio signal direction index value is between the redetermined low direction index value and redetermined high direction index value.

24. The apparatus as claimed in claim 17, wherein the apparatus is further configured to:
determine an elevation value from the elevation index value; and
determine an azimuth value from the azimuth index value.

25. A method for an apparatus for decoding a spatial audio signal direction index to a direction value, the direction index representing a point in a spherical grid generated by covering a sphere with smaller spheres, wherein the centres of the smaller spheres define points of the spherical grid the points arranged substantially equidistant from each other on circles of constant elevation, the method comprising:
obtaining a spatial audio signal direction index value;
estimating, by application of a defined polynomial comprising the spatial audio signal direction index value, a grid circle index value;
determining from the grid circle index value a low direction index value and a high direction index value; and
determining an elevation index value and an azimuth index value based on the grid circle index value, the low direction index value, the high direction index value and the spatial audio signal direction index value.

26. The method as claimed in claim 25, wherein estimating, by application of a defined polynomial comprising the spatial audio signal direction index value, a grid circle index value comprises obtaining polynomial coefficients, wherein the polynomial coefficients within the polynomial cause the polynomial to approximate a function of the cumulative index value as function of the grid circle index value.

27. The method as claimed in claim 26, further comprises obtaining a quantization or coding index value configured to define the maximum number of points within the spherical grid and obtaining polynomial coefficients comprises obtaining polynomial coefficients based on the quantization or coding index value.

28. The method as claimed in claim 27, wherein estimating, by application of a defined polynomial comprising the spatial audio signal direction index value, a grid circle index value comprises:
solving the defined polynomial, wherein the solution is the grid circle index value; and
verifying the grid circle index is within a grid circle range defined by the quantization or coding index value.

29. The method as claimed in claim 25, wherein the defined polynomial is one of:
a nth order polynomial, where n is greater than two;
a second order polynomial; and
a linear by pieces polynomial.

30. The method as claimed in claim 25, wherein determining an elevation index value and an azimuth index value based on the grid circle index value, the low direction index value, the high direction index value and the spatial audio signal direction index value comprises:
determining whether the spatial audio signal direction index value is between the low direction index value and a high direction index value;
and based on whether the spatial audio signal direction index value is between the low direction index value and a high direction index value generating an elevation index value based on the grid circle index value where the spatial audio signal direction index value is between the low direction index value and a high direction index value and determining or otherwise correcting the grid circle index value and redetermining the low direction index value and the high direction index value based on the corrected grid circle index value before redetermining whether the spatial audio signal direction index value is between the redetermined low direction index value and redetermined high direction index value.

31. The method as claimed in claim 25, wherein determining an elevation index value and an azimuth index value based on the grid circle index value, the low direction index value, the high direction index value and the spatial audio signal direction index value comprises:
determining whether the spatial audio signal direction index value is between the low direction index value and a high direction index value; and based on the determining:
determining, where the spatial audio signal direction index value is between the low direction index value and a high direction index value, the elevation is a positive elevation, the elevation index value is a grid circle index value divided by two rounded down and the azimuth index value is based on a difference between the spatial audio signal direction index value and the low direction index value;
determining, where the spatial audio signal direction index value is between the high direction index value and a combination of the high direction index value and a number of grid points on the circle identified by the grid circle index value, the elevation is a negative elevation, the elevation index value is a grid circle index value divided by two rounded down and the azimuth index value is based on a difference between the spatial audio signal direction index value and the high direction index value; and
setting the grid circle index value as a value lower, where the spatial audio signal direction index value is less than the low direction index value or otherwise setting the grid circle index value as a value higher, where the spatial audio signal direction index value is more than the combination the high direction index value and a number of grid points on the circle identified by the grid circle index value, and redetermining the low direction index value and the high direction index value based on the set grid circle index value before redetermining whether the spatial audio signal direction index value is between the redetermined low direction index value and redetermined high direction index value.

32. The method as claimed in claim 25, further comprises:
determining an elevation value from the elevation index value; and
determining an azimuth value from the azimuth index value.
